(19) United States
(12) Patent Application Publication
(10) Pub. No.: US 2008/0302647 A1
(43) Pub. Date: Dec. 11, 2008

(54) DEVICE FOR CONTROLLING AN ELECTRONIC APPARATUS

(75) Inventors: Jean-Christophe Villain, Dole (FR); Michel Cour, Sampans (FR)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/137,139

(22) Filed: Jun. 11, 2008

(30) Foreign Application Priority Data
Jun. 11, 2007 (FR) 0755650

(51) Int. Cl. H01H 13/14

(52) U.S. Cl. 200/343; 200/341

(57) ABSTRACT

In an embodiment, a device for controlling an electronic apparatus may include a top panel which can produce at least one control signal for the electronic apparatus when a pointing element comes into contact on the top face of the top panel. The device may include a support frame relative to which the top panel is fitted to move, a disengageable endstop for the top panel in a raised position, wherein the top panel is supported by a guide deck which is linked to the support frame so as to maintain the top panel orthogonal to a first plane when the top panel is moved relative to the frame.

### CROSS-REFERENCE TO RELATED APPLICATION

This application claims the benefit of priority to French Patent Application No. 0755650 filed Jun. 11, 2007, which is hereby incorporated by reference in its entirety.

### SUMMARY

In an embodiment, a device may include a substantially flat and horizontal top panel which can produce at least one control signal for an electronic apparatus when a pointing element comes into contact with the top face of the top panel. The device may include a supporting frame relative to which the top panel may be mounted to move according to a substantially vertical movement. A single element may form a disengageable endstop for the top panel in a raised position relative to the support frame. In an embodiment, the single element may be able to change state to produce a mechanical impulse of substantially vertical orientation on the top panel, by enabling the top panel to be moved as a whole downward relative to the support frame. In an embodiment, the device may relate to a multidirectional control unit.

In an embodiment, a disengageable endstop-forming element may be arranged below the top panel, so that the impulse that it produces is felt by the user, independently of the location of the point of contact of the pointing element on the top face of the top panel.

The device may not include a means for guiding the top panel in its downward movement. Thus, when operating, the top panel may tilt as a whole about an articulation point located at the level of the disengageable endstop-forming element. The tilting may imply a significant displacement of the outer edges of the top panel relative to the center of the top panel, which can disturb a user when controlling the electronic apparatus.

In an embodiment, there may be guidance means for the top panel that use vertical slideway systems. These guidance means may have relatively large dimensions, which may increase the overall height and the bulk of the device. In an embodiment, such guidance means may produce friction that reduces the tactile effect, which corresponds to the mechanical impulse produced by the endstop-forming element, and which may be felt by a user.

The device may include means of guiding the top panel to have a low impact on the bulk of the device and produce little friction.

To this end, the device as described previously may have a top panel that may be supported by a guide deck which is linked to the support frame so as to maintain the top panel orthogonal to a vertical longitudinal plane when the top panel is moved vertically relative to the frame.

According to an embodiment, the deck may be linked to the support frame by means of guiding the deck in its downward movement, so as to maintain the top panel parallel to a horizontal plane, when the top panel is moved vertically relative to the frame, which may include a hinged guide structure arranged vertically between the deck and the frame which may include at least two arms hinged about at least one transverse axis.

In an embodiment, the two hinged arms may be parallel to each other and may be longitudinally offset, and a top end of each arm may be hinged relative to the deck about a transverse axis and a bottom end of each arm may be hinged relative to the frame about a transverse axis, so as to form a structure of the deformable parallelogram type.

In an embodiment, at least two arms may be hinged relative to each other about a transverse axis. In an embodiment, the guide deck may be fitted to pivot relative to the support frame about a horizontal transverse axis which is longitudinally offset backward relative to a rear end of the top panel. In an embodiment, the deck may include a front plate which may support the top panel and a rear plate linking the front plate to the support frame. The rear longitudinal end of the rear plate may be hinged relative to the support frame about the transverse axis.

In an embodiment, the support frame may include a transverse vertical rear wall on which the rear plate of the deck may be fitted hinged, and a horizontal top wall, which may extend horizontally forward from a top end edge of the rear wall, at least partly covering the deck.

In an embodiment, the top wall may cover the rear plate of the deck, and the horizontal top face of the top wall may be flush with a horizontal top face of the top panel or of the front plate of the deck.

In an embodiment, the input device may include an intermediate deck arranged vertically between the deck and the endstop-forming element which may be hinged relative to the frame about a transverse axis longitudinally offset forward relative to a front end of the top panel.

In an embodiment, at least one section of the guide deck may be able to be elastically deformed to enable the top panel to move downward. In an embodiment, the deck may include a substantially horizontal plate which may be elastically deformed downward by flexing when the top panel is moved vertically relative to the frame. In an embodiment, at least one longitudinal end of the plate may be linked to the frame. The two opposite longitudinal ends of the plate may be linked to the frame.

In an embodiment, the deck may include a transverse vertical leg which extends vertically downward from at least one longitudinal end of the plate which may be linked to the frame. The leg may be elastically deformed when the top panel is moved vertically relative to the frame. The deck may have a transverse vertical plane of symmetry and the top panel may be arranged substantially longitudinally in the middle of the deck.

In an embodiment, the single element may form a tactile-effect electrical switch. In an embodiment, the top panel may include a tactile faceplate.

### BRIEF DESCRIPTION OF THE DRAWINGS

Other characteristics and advantages will become apparent from reading the detailed description that follows, for an understanding of which reference should be made to the appended figures in which:

FIG. 1 is a perspective diagrammatic representation of the device according to an embodiment.

FIG. 2 is an exploded perspective diagrammatic representation of the device represented in FIG. 1, showing the hinge arms of the deck relative to the support frame according to an embodiment.

FIG. 3 is a section along a vertical longitudinal plane of the device represented in FIG. 2 according to an embodiment.

FIG. 4 is a section similar to that represented in FIG. 3, showing a device including a deck that is hinged directly relative to the support frame according to an embodiment.

FIG. 5 is a section similar to that represented in FIG. 4 in which the device includes a second deck that is hinged relative to the support frame according to an embodiment.

FIG. 6 is a section similar to that represented in FIG. 3 in which the device includes an elastically deformable deck according to an embodiment.

FIG. 7 is a section similar to that represented in FIG. 6 in which the device includes elastically deformable deck according to an embodiment.

### DETAILED DESCRIPTION

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

As used herein and in the appended claims, the singular forms “a,” “an,” and “the” include the plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

As used herein, the use of the terms “right” and “left” are non-limiting and the elements may be depicted in any order.

As used herein, the use of the terms “top” and “bottom” shall also be adopted with reference to the vertical orientation “V” indicated in the figures. These terms are non-limiting and the elements may be depicted in any order.

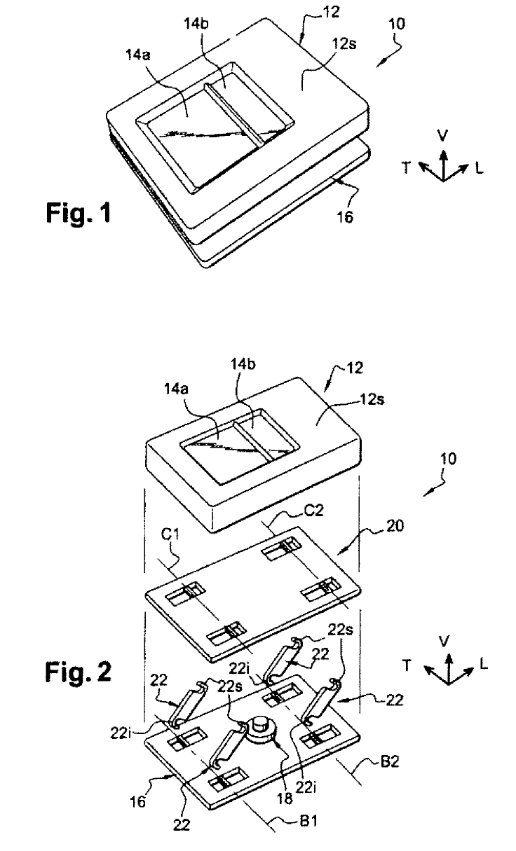

The use of “V,” “L” and “T” are references to the vertical, longitudinal and transverse directions respectively. However, these directions are non-limiting and the device and elements of the device may be depicted in any configuration. The front to rear orientation shall also be adopted as the longitudinal direction, shown left to right in FIG. 1.

Additionally, in the description that follows, identical, similar or analogous elements are denoted by the same reference numerals.

FIG. 1 depicts a device 10, also called input device, for controlling an electronic apparatus according to an embodiment. In an embodiment, the device 10 may be used for controlling an electronic apparatus which is fitted in a motor vehicle. The device 10 may include a top panel 12, such as, for example, a tactile faceplate, on which a user acts to control the electronic apparatus. In an embodiment, a pointing element (not represented) such as, but not limited to, a stylus or a finger of the user, can come into contact with the top face 12s of the top panel 12. The electronic apparatus may be controlled via the device 10 by applying a control action on the top face 12s of the top panel, via the pointing element. The top panel 12 may be produced so that it is possible to determine the location of the point of contact of the pointing element on the top face 12s of the top panel 12.

In response to the contact of the pointing element on the top face 12s of the top panel, the top panel 12 may produce one or more electrical control signals, which are transmitted to an electronic control device of the electronic apparatus, to apply a predefined action. In an embodiment, the top face 12s of the top panel 12 may be divided into two control zones 14a, 14b, each of which is associated with a control of the electronic apparatus.

As can be see in FIGS. 2-7, the device may include a support frame 16 on which the top panel 12 is fitted. In an embodiment, the top panel 12 of the device 10 may be fitted to move relative to the frame 16 with a substantially vertical movement. The vertical movement of the top panel 12 may enable the device 10 to receive an additional control action which may include applying to the top face 12s of the top panel 12 a pressure force oriented downward via the pointing element. The pressure force value may be greater than a predetermined threshold value. The additional control action may be detected via a single element 18 which may be arranged between the top panel 12 and the support frame 16. In an embodiment, the single element 18 may form an electrical switch which can establish a switching path between two electrical contacts associated with the single element 18 when it changes state. The single element 18 may include an electrically conductive material, which is elastically deformable. The single element 18 may be in permanent contact with one of the two electrical contacts, and a portion of the single element 18 may be located away from the second electrical contact.

In an embodiment, when the user applies the control action, the single element 18 may be deformed so that a portion of the single element comes into contact with the second electrical contact. The single element 18 may electrically link the two electrical contacts, which may provoke the transmission of an electrical control signal associated with the switching to the electronic control device, to apply a predefined action, such as, for example, an enabling or selecting action.

The single element 18 also may form an endstop for the top panel 12 in a raised position relative to the support frame 16, and can change states to enable a downward movement of the top panel 12 when the value of the pressure force is greater than the threshold value. The single element 18 may form a disengageable endstop for the top panel 12 in the raised position.

When the single element 18 changes state, the top panel may be moved abruptly downward relative to the support frame 16. This abrupt movement may be transmitted and felt by the user in a way similar to a “click” of a pushbutton. The single element 18 may make it possible to produce a tactile sensation when the user applies the control action on the top panel 12. In an embodiment, the single element 18 forms a switch which may produce a tactile effect.

According to an embodiment, the device 10 may include a deck 20 for guiding the top panel 12 in its movement relative to the support frame 16. The deck 20 may be arranged vertically between the top panel 12 and the single element 18, so that the frame transmits the control action from the top panel 12 to the single element 18. In an embodiment, the deck 20 may move relative to the support frame 16 so as to retain a certain orientation of the top panel 12 relative to the support frame 16. In an embodiment, the deck 20 may be produced so as to maintain the top panel 12 perpendicular to a vertical longitudinal plane when the top panel 12 is moved downward relative to the support frame 16.

According to an embodiment, in FIGS. 1-3, the deck 20 may be linked to the support frame 16 via a hinged structure which may make it possible to maintain the top panel 12 in a horizontal position when it is moved vertically. When the user applies an additional control action, the top panel 12 may perform a translational motion oriented primarily downward. The movement of any point of the top face 12s of the top panel 12 may be identical regardless of its longitudinal and/or vertical position on the top face 12s of the top panel 12. An identical movement of any point of the top panel 12 may not disturb the user when the user applies additional control actions to different positions on the top face 12s of the top panel 12.

The hinged structure may include arms 22 which are linked to the deck 20 and to the frame 16. According to an embodiment, four arms 22 may be distributed in pairs, so that the arms 22 of a pair may be longitudinally aligned, and the two pairs of arms may be parallel.

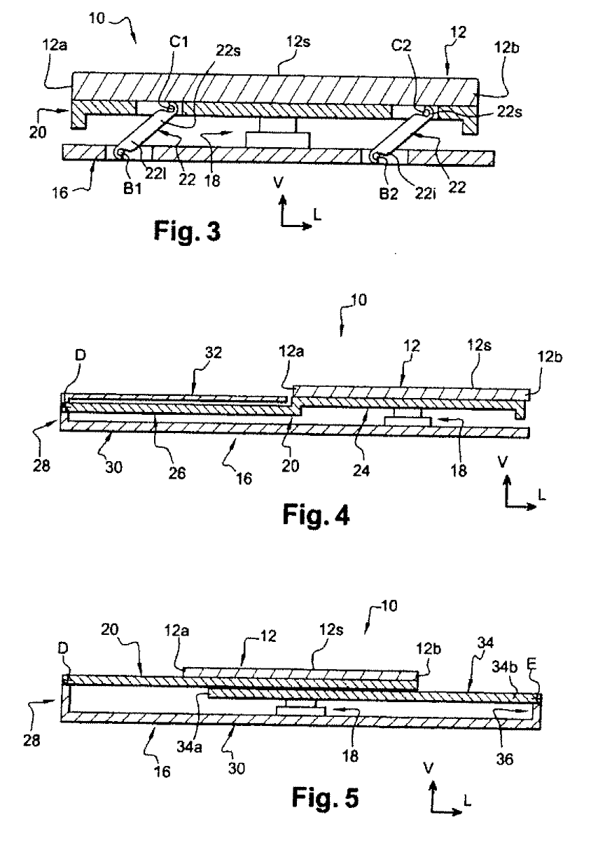

As can be seen in FIG. 3, the hinged structure linking the deck 20 to the support frame 16 may form, in cross-section on a vertical longitudinal plane, a deformable quadrilateral, such as, but not limited to, a deformable parallelogram. The parallelogram may include two parallel horizontal sides formed by the deck 20 and the support frame 16. The other two sides of the parallelogram may be formed by the arms 22 of a pair of arms, and each arm 22 may be hinged relative to the deck 20 and relative to the frame 16 about a transverse axis.

Each arm 22 may be inclined relative to a horizontal plane and relative to a vertical transverse plane. The two arms 22 may be parallel to each other and may be longitudinally offset. The angle of inclination of the arms 22 relative to a horizontal plane may be determined so as to limit the amplitude of the longitudinal component of the movement of the deck 20. The movement of the top panel 12 relative to the support frame 16 may be oriented primarily vertical. The length of the arms 22 and their inclination may be defined so as to limit the vertical bulk of the hinged structure and the overall vertical bulk of the device.

The top end 22s of each arm 22 may be hinged relative to the deck 20 about a transverse top axis C1, C2, and the bottom end 22i of each arm 22 may be hinged relative to the frame 16 about a transverse bottom axis B1, B2.

According to an embodiment that is not represented, the arms 22 may cross and may be hinged relative to each other about a transverse axis. According to this variant, only one end of each arm may be hinged relative to the deck 20 or relative to the frame 16. The other end of each arm may be free to move longitudinally relative to the frame 16 or relative to the deck 20, respectively.

It will be understood that the embodiments described above of the hinged structure are non-limiting, and that the hinged structure can include a different number of arms 22.

The upward vertical return of the deck 20 to its top rest position represented in FIG. 3 may be produced via the single element 18, which applies to the deck 20 an elastic return force that is oriented upward. According to an embodiment, the upward return of the deck 20 may be produced via elastic return means (not represented) such as, but not limited to, elastic springs, arranged between the deck 20 and the frame 16.

FIG. 4 represents a cross section to which the deck 20 is fitted to tilt relative to the frame 16 about a transverse axis D according to an embodiment. The transverse axis D may be longitudinally offset backward relative to a rear end edge 12a of the top panel 12. Thus, each point of the top face 12s of the top panel 12 may be moved vertically downward along a predetermined trajectory, which may be an arc of circle centered on the transverse axis D, when the user applies the additional control action, regardless of the position of the point of contact of the pointing element on the top face 12s of the top panel 12.

The longitudinal distance between the transverse axis D and the rear end edge 12a of the top panel 12 may be determined so as to reduce the difference in downward vertical travel of a contact point located close to the rear end edge 12a of the top panel 12 and relative to a contact point located close to the front end edge 12b of the top panel 12. The deck 20 may include a front plate 24 which may support the top panel 12 and a rear plate 26 which may link the front plate 24 to a frame 16. The front plate 2 and the rear plate 26 may be horizontal. The rear longitudinal end 26a of the rear plate 26 may be hinged relative to the frame 16 about the transverse axis D. The longitudinal length of the rear plate 26 may be determined so that the rear edge 12a of the top panel may be located at the longitudinal distance from the transverse axis 1, defined previously.

The frame 16 may include a rear vertical transverse wall 28 which may extend vertically upward from a horizontal bottom portion 30 of the frame 16, and on which rear wall 28 the rear end 26a of the rear plate 26 of the deck 20 may be hinged about the transverse axis D. The frame 16 may include a horizontal top wall 32 which may extend above the rear plate 26 of the deck 20. The top wall 32 may cover the rear plate 26 of the deck 20 to prevent any operation of the single element 18 when the user does not act on the top panel 12. In an embodiment, the top wall 32 may be produced so that it is flush with the top face 12s of the top panel 12. The top wall 32 may support switches (not represented) for controlling the electronic apparatus, which may or may not be associated with the top panel 12.

FIG. 5 represents an embodiment of the device 10, which comprises an intermediate deck 34 which is arranged vertically between the deck 20 and the single element 18. The intermediate deck 34 may extend longitudinally in front of the deck 20 and may be hinged relative to the deck about a second transverse axis E located in front of the top panel 12.

The secondary deck 34 may make it possible to modify the distribution of the forces applied to the single element 18, so as to limit the difference in the value of the forces to be produced on the top face 12s of the top panel 12, which provoke the change of state of the single element 18, according to the longitudinal position of the point of contact of the pointing element on the top face 12s of the top panel 12. In an embodiment, the secondary deck 34 may be horizontal and may extend longitudinally forward beyond the front longitudinal end edge 12b of the top panel 12.

In an embodiment, the rear end 34a of the secondary deck 34 may be located at the level of the rear edge 12a of the top panel 12, and the front end 34b of the secondary deck 34 may be hinged relative to a front vertical wall 36 of the frame 16 about the second transverse axis E.

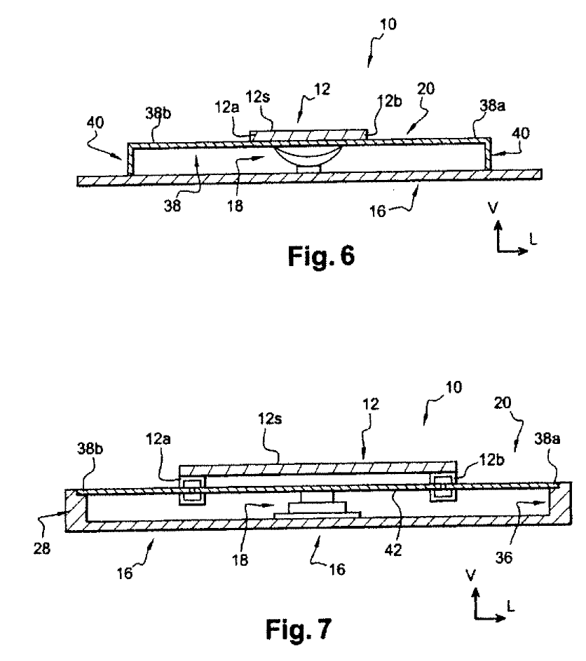

FIG. 6 represents an embodiment of the deck 20 which can be deformed elastically when the top panel 12 is moved downward in response to the additional control action applied by the user to the top panel 12. The deck 20 may include an elastically deformable material, and may include a horizontal flexible plate 38 which can be elastically deformed by flexing when the top panel 12 is moved downward. In an embodiment, the front longitudinal end 38a and the rear longitudinal end 38b of the flexible plate 38 may bear on the frame 16, and the top panel 12 may be located substantially longitudinally in the middle of the flexible plate 38.

According to an embodiment that is not represented, only one longitudinal end of the flexible plate 38 may be linked to the frame 16. The top panel 12 may be fitted on the other longitudinal end of the flexible plate 38. In an embodiment, the deck 20 may include a transverse vertical leg 40 which extends vertically downward from each longitudinal end 38a, 38b of the flexible plate, to the frame 16. The legs 40 may include a single piece with the flexible plate 38 and are able to be elastically deformed when the top panel 12 is moved downward.

The longitudinal length of the flexible plate 38 may be determined so as to limit the difference between the amplitude of the force that the user must apply to the top panel 12 to provoke the deformation of the single element 18 between a point of contact located level with the center of the top face 12s of the top panel 12, and a point of contact located in the vicinity of a longitudinal end edge 12a, 12b of the top panel 12.

According to an embodiment represented in FIG. 7, the opposite longitudinal ends 38a, 38b of the flexible plate 38 may bear directly on the frame 16. For example, each longitudinal end 38a, 38b of the flexible plate 38 may bear downward against a rear 28 or front 36 transverse vertical wall of the frame 16. The top panel 12 may be linked to the flexible plate 38 at the level of its front and rear longitudinal end edges 12h, 12a. Each end edge 12a, 12h of the top panel may be hinged relative to the flexible plate 38 about a transverse axis located on the flexible plate 38. This enables the flexible plate 38, and also the central part 42 of the flexible plate 38, which is located under the top panel 12, to be freely deformed when the top panel 12 is moved vertically downward.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1 A device for controlling an electronic apparatus comprising:
a top panel parallel to a first plane and configured to produce at least one control signal for the electronic apparatus when a pointing element comes into contact on a top face of the top panel;
a support frame relative to which the top panel is mounted to move relative to a second plane, wherein the second plane is perpendicular to the first plane; and
a single element forming a disengageable endstop for the top panel in a raised position relative to the support frame, wherein the single element is configured to change state to produce a mechanical impulse on the top panel, by enabling the top panel to move downward relative to the support frame,
wherein the top panel is supported by a guide deck which is linked to the support frame to maintain the top panel orthogonal to the second plane when the top panel is moved relative to the frame.

2. The device of claim 1 wherein the guide deck is linked to the support frame by guiding the deck in its downward movement to maintain the top panel parallel to the first plane when the top panel is moved relative to the frame, which comprises a hinged guide structure arranged between the deck and the frame, which comprises at least two arms hinged about at least one transverse axis.

3. The device of claim 2 wherein the two arms are parallel to each other and are offset, and wherein a top end of each arm is hinged relative to the deck about a transverse axis and a bottom end of each arm is hinged relative to the frame about a transverse axis, which is configured to form a deformable parallelogram structure.

4. The device of claim 2 wherein the two hinged arms are hinged relative to each other about a transverse axis.

5. The device of claim 1 wherein the guide deck is fitted to pivot relative to the support frame about a transverse axis which is offset relative to a rear end of the top panel.

6. The device of claim 5 wherein the guide deck comprises a front plate which supports the top panel and a rear plate linking the front plate to the support frame, wherein a rear end of the rear plate is hinged relative to the support frame about the transverse axis.

7. The device of claim 6 wherein the support frame comprises a rear wall on which the rear plate of the guide deck is hinged, and a top wall, which extends from a top end edge of the rear wall, and covers at least a part of the deck.

8. The device of claim 7 wherein the top wall covers the rear plate of the guide deck and a top face of the top wall is flush with the top face of the top panel.

9. The device of claim 7 wherein the top wall covers the rear plate of the guide deck and a top face of the top wall is flush with a top face of the front plate of the guide deck.

10. The device of claim 1 wherein the device further comprises:
an intermediate deck arranged between the guide deck and an endstop-forming element, which is hinged relative to the frame about a transverse axis offset relative to a front end of the top panel.

11. The device of claim 1 wherein at least one section of the guide deck is configured to be elastically deformed to enable the top panel to move downward.

12. The device of claim 1 wherein the guide deck comprises a plate which is configured to be elastically deformed by flexing when the top panel is moved relative to the frame.

13. The device of claim 12 wherein at least one end of the plate is linked to the frame.

14. The device of claim 12 wherein two opposite ends of the plate are linked to the frame.

15. The device of claim 13 wherein the deck comprises a leg which extends from the at least one end of the plate which is linked to the frame.

16. The device of claim 15 wherein the leg is configured to elastically deform when the top panel is moved relative to the frame.

17. The device of claim 11 wherein the deck has a transverse plane of symmetry and the top panel is arranged in the middle of the guide deck.

18. The device of claim 1 wherein the single element forms a tactile-effect electrical switch.

19. The device of claim 1 wherein the top panel comprises a tactile faceplate.
